(19) United States
(12) Patent Application Publication
(10) Pub. No.: US 2025/0342372 A1
(43) Pub. Date: Nov. 6, 2025

(54) CONCURRENT RUNNING OF INFERENCE WORKLOAD INSTANCES ON THE SAME DEVICE RESOURCE USING WORKLOAD AFFINITY

(71) Applicant: Lenovo Enterprise Solutions (Singapore) Pte Ltd., Singapore (SG)

(72) Inventors: Tianyi Gao, Greensboro, NC (US); Jiali Cheng, Apex, NC (US); Jianfeng Guo, Cary, NC (US); Jun Liu, San Jose, CA (US)

(21) Appl. No.: 18/655,264

(22) Filed: May 5, 2024

(51) Int. Cl. G06N 5/04

(52) U.S. Cl. CPC G06N 5/04

(57) ABSTRACT

A computer program product provides program instructions executable by a processor to cause the processor to perform operations. The operations include identifying a first inference workload instance using a first inference model and a second inference workload instance using a second inference model and identifying whether the first and second inference models have affinity for being run concurrently on a core processing unit. The first and second inference models have affinity if the first and second inference workload instances can run concurrently on the core processing unit without causing either of the first and second inference workload instances to experience latency above a predetermined limit. The operations further include causing the first and second inference workload instances to be run concurrently on the core processing unit if the first and second inference models have been identified to have affinity for being run concurrently on the core processing unit.

### BACKGROUND

The present disclosure relates to scheduling of artificial intelligence inference workloads to be performed by a hardware resource, such as a graphics processing unit.

### BACKGROUND OF THE RELATED ART

Artificial intelligence (AI) generally refers to technology that enables computers and machines to simulate human intelligence and problem-solving capabilities. Within the field of computer science, artificial intelligence encompasses machine learning, deep learning and neural networks. An AI model is a software program that can detect specific patterns in a training data set. For example, an AI model may include a complicated algorithm or layers of algorithms that analyze data and make judgements based on that data. Once the AI model has been training on the training data set, the trained AI model can be used to draw conclusions or inferences based on new data-a process referred to as “inference.” For example, an AI model may be trained to recognize a truck by providing the AI model with training data that includes a large number of images of trucks of various makes, models, colors, sizes and orientations, etc. Subsequently, the trained AI model may be able to recognize or infer that an image includes a truck even though that particular truck was not provided in the training data. In addition to image recognition, AI models can be used for a variety of other tasks including natural language processing, anomaly detection, forecasting and control systems.

Graphics Processing Units (GPUs) are specialized electronic circuits initially designed to accelerate computer graphics and image processing. Such GPUs may be found on video cards, mobile phones, personal computers and game consoles. However, due to their parallel processing structure, GPUs have been found to be useful for non-graphic calculations such as AI inference. Each GPU chip includes several core processing units that perform parallel calculations. Such core processing units are referred to as “streaming multiprocessors” for NVidia GPUs, “compute units” for AMD GPUs, and “Xe cores” for Intel GPUs. Each core processing unit includes floating-point units (FPUs), memory and control units that enable the core processing unit to perform multiple simultaneous mathematical operations. In fact, some core processing units can efficiently execute thousands of small threads concurrently.

### BRIEF SUMMARY

Some embodiments provide a computer program product comprising a non-volatile computer readable medium and non-transitory program instructions embodied therein, the program instructions being configured to be executable by a processor to cause the processor to perform various operations. The operations comprise identifying a plurality of inference workload instances, wherein the plurality of inference workload instances includes a first inference workload instance using a first inference model and a second inference workload instance using a second inference model. The operations further comprise identifying whether the first and second inference models have affinity for being run concurrently on a particular hardware configuration of a core processing unit, wherein the first and second inference models have affinity for being run concurrently on the particular hardware configuration of the core processing unit if the first and second inference workload instances can run concurrently on the core processing unit without causing either of the first and second inference workload instances to experience latency above a predetermined limit. the operations also comprise causing the first and second inference workload instances to be run concurrently on the core processing unit if the first and second inference models have been identified to have affinity for being run concurrently on the core processing unit.

Some embodiments provide a computer program product comprising a non-volatile computer readable medium and non-transitory program instructions embodied therein, the program instructions being configured to be executable by a processor to cause the processor to perform various operations. The operations comprise identifying a plurality of inference workload instances, wherein the plurality of inference workload instances includes a first inference workload instance using a first inference model and a second inference workload instance using a second inference model. The operations further comprise identifying whether the first and second inference models have affinity for being run concurrently on a particular hardware configuration of a core processing unit, wherein the first and second inference models have affinity for being run concurrently on the particular hardware configuration of the core processing unit if the core processing unit has a hardware resource configuration that meets or exceeds a combination of the hardware resource requirements of the first and second inference models. the operations also comprise causing the first and second inference workload instances to be run concurrently on the core processing unit if the first and second inference models have been identified to have affinity for being run concurrently on the core processing unit.

### BRIEF DESCRIPTION OF THE SEVERAL VIEWS OF THE DRAWINGS

FIG. 1A is a diagram of a system for improving the utilization of an inference computing resource pool that uses affinity-aware concurrent launching of certain inference workloads.

FIG. 1B is a diagram of the system of FIG. 1A showing additional details.

FIG. 2A is a diagram of a Graphics Processing Unit including multiple core processing units.

FIG. 2B is a diagram of a single core processing unit having a different set of hardware resources than the core processing units of FIG. 1.

FIG. 3 is a diagram of a core processing unit annotated to illustrate the hardware resources utilized by a first inference workload instance running alone on the core processing unit.

FIG. 4 is a diagram of the core processing unit annotated to illustrate the hardware resources simultaneously utilized by a first inference workload instance and a second inference workload instance having the best possible affinity for this particular core processing unit.

FIG. 5 is a diagram of the core processing unit annotated to illustrate the hardware resources simultaneously utilized by a first inference workload instance and a second inference workload instance having good affinity (no competition for resources, but also some unused resources) for this particular core processing unit.

FIG. 6 is a diagram of the core processing unit annotated to illustrate the hardware resources simultaneously utilized by a first inference workload instance and a second inference workload instance having good affinity (only minor competition for resources, and only minor unused resources) for this particular core processing unit.

FIG. 7 is a diagram of the core processing unit annotated to illustrate the hardware resources simultaneously utilized by a first inference workload instance and a second inference workload instance having bad affinity (major competition for resources, and significant unused resources) for this particular core processing unit.

FIGS. 8A-C are illustrations of a data structure that may be used to store a Workload Queue, Annotated Model Metrics, and Model Affinity Metrics, respectively.

FIG. 9 is a flowchart according to some embodiments.

FIG. 10 is a flowchart (swim lane diagram) showing the interaction between entities of a system according to some embodiments.

FIG. 11 is a block diagram of one embodiment of a computer.

### DETAILED DESCRIPTION

Some embodiments provide a computer program product comprising a non-volatile computer readable medium and non-transitory program instructions embodied therein, the program instructions being configured to be executable by a processor to cause the processor to perform various operations. The operations comprise identifying a plurality of inference workload instances, wherein the plurality of inference workload instances includes a first inference workload instance using a first inference model and a second inference workload instance using a second inference model. The operations further comprise identifying whether the first and second inference models have affinity for being run concurrently on a particular hardware configuration of a core processing unit, wherein the first and second inference models have affinity for being run concurrently on the particular hardware configuration of the core processing unit if the first and second inference workload instances can run concurrently on the core processing unit without causing either of the first and second inference workload instances to experience latency above a predetermined limit. the operations also comprise causing the first and second inference workload instances to be run concurrently on the core processing unit if the first and second inference models have been identified to have affinity for being run concurrently on the core processing unit.

The operations are performed by the processor of a computer to cause the inference workload instances to be run on the core processing unit. The computer where the processor performs the operations may be the same or different computer than the computer where the core processing unit runs the inference workload instances. Inference workload instances are jobs that apply an inference model to some data and produce an output. These inference workload instances are run (i.e., performed) on a core processing unit of a Graphics Processing Unit (GPU). In one option, the program instructions of one or more of the embodiments are executable by a processor that is a central processing unit (CPU) of a first computer or server to cause the inference workload instances to be run on the core processing unit of a GPU in a second computer or server. Furthermore, the GPU may be included in an inference computing resource pool that includes many GPUs, each with their own plurality of core processing units, for running inference workload instances that use various inference models. Non-limiting examples of the inference models include large language models, image recognition, speech recognition and an ever-expanding list of applications of these and other models, which may be provided as services. However, it should be appreciated that the program instructions of the computer program product described in reference to the embodiments herein may be partially or entirely run on a processor that is a central processing unit and may be partially or entirely run on a computer or server that is not included in the inference computing resource pool.

In some embodiments, the core processing unit is one of multiple core processing units in a graphics processing unit. The inference workload instances run on each of the core processing units may be independently managed according to one or more of the embodiments. The core processing units may be referred to as streaming multiprocessors, compute units and/or Xe cores depending upon the manufacturer of the GPU.

An inference workload instance is a single job that uses or applies an inference model. Accordingly, an inference workload instance may identify the inference model to be used and the data to be processed by the inference model. Optionally, the inference workload instance may include the inference model or more simply identify the inference model that should be called and applied to the data. Each inference model is a trained artificial intelligence model that may be used to apply its training to make inferences with respect to new data.

Embodiments identify whether a two or more inferences models, such as the first and second inference models, have affinity for being run concurrently on a particular hardware configuration of a core processing unit. The term “concurrently” means occurring at the same time. Accordingly, two inference workload instances are running concurrently if the two inference workload instances are both running on the same core processing unit at the same time. Two inference workload instances may be concurrently running on the same core processing unit regardless of whether or not the two inference workload instances are launched in a simultaneous or staggered manner, so long as there is some overlapping period of time where both inference workload instances are running on the same core processing unit.

Two or more inference models may be described as having “affinity” for being run concurrently on the particular hardware configuration of the core processing unit if inference workload instances using those two or more inference models can run concurrently on the core processing unit without causing any of those inference workload instances to experience latency above a predetermined limit. For example, the predetermined limit for latency of a given inference model or inference workload instance may be set or established by a service level agreement (SLA), such as an SLA between a client submitting the inference workload instance and a cloud service provider providing the inference resource pool (i.e., GPUs and their core processing units). Affinity may be described with reference to the inference models because the nature of the inference model is a substantial factor in the demand for the hardware resources of the core processing unit. For example, inference workloads using one inference model may utilize 16 FP32 (single-precision floating-point) units and other resources whereas inference workloads using another inference model may utilize 16 INT32 (32-bit signed integer) unit and other resource. These two inference models may have affinity for being run concurrently on a particular core processing unit if the core processing unit has a sufficient number of FP32 units, INT32 units and other hardware resources so that the inference workload instances using those two inference models may run concurrently on the same core processing unit without competing for resources to such an extent that one or more of the inference workload instances experiences latency that exceeds a predetermined latency limit.

In some embodiments, it is not necessary to measure or quantify the resource requirements of the inference models on a particular core processing unit since it is possible to launch workload instances using various inference model combinations and then determine affinity of each inference model combination according to the amount of latency experienced. In other words, those combinations of inference models that are able to be run concurrently on the same core processing unit without exceeding the latency limit are determined to have affinity. In other embodiments, the resource requirements of each inference model may be measured by running inference workload instances using these inference models on a core processing unit without any other workload instances, then a given combination of inference models may be determined to have affinity for a particular core processing unit if the combination of the inference models' measured resources requirements are less than the resources that are available on the particular core processing unit. Associating an inference model with its resource requirements, such as by storing the inference model identifier and the resource requirements of the inference model in a common record, may be referred to herein as “annotation.”

In some embodiments, the operations may include preventing the first and second inference workload instances from being run concurrently on the core processing unit unless the first and second inference models have been identified to have affinity for being run concurrently on the core processing unit. In other words, rather than causing one or more of the first and second inference workload instances to experience latency exceeding the limit, the first and second inference workloads may be run consecutively (i.e., not concurrently) on the particular core processing unit, the first and second inference workloads may be run on separate core processing units, or the first and second inference workloads may be run concurrently on a core processing unit having a different hardware configuration such that the inference models' measured resources requirements are less than the resources that are available on the different core processing unit. For example, core processing units having different hardware configurations, such as different types and numbers of units or components therein, may be found in a different GPU model, type or version.

In some embodiments, the first and second inference workload instances are both identified in a workload queue, wherein the first and second inference workload instances are caused to run concurrently on the core processing unit by simultaneously launching the first and second inference workload instances to be run on the core processing unit. The simultaneous launching of the first and second inference workload instances may occur, for example, where a core processing unit becomes available due to completion of some other workload instance, or a new set of GPUs being turned on. Once the core processing unit is available, if the first and second inference workloads instances are both found in the workload queue and have affinity for being run concurrently on the available core processing unit then a workload allocator may simultaneously launch the first and second inference workload instances to be run concurrently on the core processing unit.

In some embodiments, the first and second inference workload instances are caused to run concurrently on the core processing unit by launching the first inference workload instance from a workload queue to be run on the core processing unit and subsequently launching the second inference workload instance from the workload queue to be run on the core processing unit where the first inference workload instance is already running. This situation may occur when the first and second inference workload instances are not in the workload queue at the same time. Accordingly, the first inference workload instance may be launched to the core processing unit at a time when there are no other workload instances in the workload queue having affinity with the first inference workload instance. However, if a second inference workload instance is subsequently received into the workload queue, the second inference workload instance may be launched to the same core processing unit that is already running the first inference workload instance. As a result, the first and second inference workload instances are run concurrently on the same core processing unit despite not having been in the workload queue at the same time and not being launched at the same time.

In some embodiments, inference workload instances within the workload queue may be assigned to be run on an available core processing unit on a first-in, first-out (FIFO) basis except that any identified inference workload instance within the workload queue may be selected to be run on the core processing unit out of order if the identified inference workload instance can be run concurrently with another inference workload instance that is being selected on the first-in, first out basis. So, if there is affinity between first and second inference models and a first inference workload instance using the first inference model is next in line to be processed or run (i.e., is at the head of the queue), then a second inference workload instance using the second inference model may be identified further back in the workload queue (i.e., is the 10th inference workload instance back from the head of the queue or anywhere else in the queue) and launched simultaneously with the first inference workload instance. While the second inference workload instance got to skip forward in the queue ahead of other inference workload instance due to its inference model having affinity with the inference model used by the first inference workload instance, this launching represents a gain in the capacity utilization of the core processing unit. In one option, if the first inference workload model also has affinity for a third workload model for which there is a third inference workload instance closer to the head of the workload queue than the second inference workload instance, then embodiments may select launch the first and third inference workload instances to the core processing unit and keep the second inference workload instance in the workload queue until either it advances to the head of the workload queue or can be launched due an affinity with the inference model of another inference workload instance that has advanced to the head of the workload queue. Other schemes for efficiently scheduling or launching workload groups or pairs having affinity for an available core processing unit may be readily envisioned in light of the foregoing disclosure. For example, some inference workload instances may identify a priority level that enables those inference workload instances to be moved to the head of the workload queue.

In some embodiments, the operations may further comprise storing inference model affinity data that identifies a plurality of inference model affinity groups, wherein each inference model affinity group identifies two or more inference models having affinity to be run (i.e., inference workload instances using the two or more inference models can be run) concurrently on the particular hardware configuration of the core processing unit. In one option, the plurality of inference model groups may include inference model pairs. In another option, the operation of identifying whether the first and second inference models have affinity for being run concurrently on a particular hardware configuration of a core processing unit may include accessing the stored inference model affinity data. While the inference model groups have been describe primarily in the context of combinations of different inference models, some embodiments may also include at least one inference model group where the two or more inference models are the same inference model. In other words, if two inference workload instances using the same inference model can be run concurrently on the same core processing unit without experiencing latency exceeding a latency limit, then that inference model has affinity for itself as to the particular core processing unit.

In some embodiments, the operations may further comprise storing inference model affinity data that identifies, for each of a plurality of core processing unit configurations, a plurality of inference model affinity groups, wherein each inference model affinity group identifies two or more inference models having affinity to be run concurrently on a particular one of the core processing unit configurations. These embodiments recognize that affinity between two inference models may vary according to the hardware configuration of the core processing unit. Accordingly, if a given inference computing resource pool has multiple core processing unit configurations, such as where there are multiple GPU models, types or versions within the pool, then there may be separate inference model affinity determinations made for each of the core processing unit configurations and separate inference model affinity data stored for each of the core processing unit configurations. It is possible that the inference model affinity data may include at least one inference model affinity group that has affinity to be run concurrently on a first one of the core processing unit configurations, wherein the inference models of that inference model affinity group do not have affinity (i.e., do not form an inference model affinity group) to be run concurrently on a second one of the core processing unit configurations.

In some embodiments, the operations may further comprise verifying affinity between any two inference models by measuring an amount of latency experienced by either of the two workload instances using the two inference models that are being run concurrently on the core processing unit, wherein affinity between the first and second inference models for being run concurrently on a particular hardware configuration of a core processing unit is negated in response to the measured amount of latency experienced by either of the two workload instances exceeding a predetermined amount of latency relative to running the two workload instances on separate core processing units having the particular hardware configuration. Optionally, the predetermined amount of latency may be defined by a service level agreement. It should be appreciated that affinity determinations and records may be dynamically updated in response to detected changes in latency experienced by any workload instances running concurrently with other workload instances.

Some embodiments provide a computer program product comprising a non-volatile computer readable medium and non-transitory program instructions embodied therein, the program instructions being configured to be executable by a processor to cause the processor to perform various operations. The operations comprise identifying a plurality of inference workload instances, wherein the plurality of inference workload instances includes a first inference workload instance using a first inference model and a second inference workload instance using a second inference model. The operations further comprise identifying whether the first and second inference models have affinity for being run concurrently on a particular hardware configuration of a core processing unit, wherein the first and second inference models have affinity for being run concurrently on the particular hardware configuration of the core processing unit if the core processing unit has a hardware resource configuration that meets or exceeds a combination of the hardware resource requirements of the first and second inference models. the operations also comprise causing the first and second inference workload instances to be run concurrently on the core processing unit if the first and second inference models have been identified to have affinity for being run concurrently on the core processing unit. In such an embodiment, there is at least an initial expectation that the first and second inference workload instances can be run concurrently on the core processing unit without any significant latency since the core processing unit has a hardware resource configuration that meets or exceeds a combination of the hardware resource requirements of the first and second inference models. In other words, the hardware resource configuration of the core processing unit is sufficient to meet the concurrent hardware resources requirements of both the first and second inference models so there is no expectation of either inference model experiencing latency as a result of being run concurrently on the same core processing unit.

In some embodiments, the operations may further comprise identifying first hardware resource requirements for running an inference workload instance that uses the first inference model, wherein the first hardware resource requirements include a first plurality of hardware resource types and a number of units of each hardware resource type in the first plurality of hardware resource types; identifying second hardware resource requirements for running an inference workload instance that uses the second inference model, wherein the second hardware resource requirements include a second plurality of hardware resource types and a number of units of each hardware resource type in the second plurality of hardware resource types; and identifying a hardware resource configuration of the core processing unit, wherein the hardware resource configuration includes a third plurality of hardware resource types and a number of units of each hardware resource type in the third plurality of hardware resource types. With this information identified, the operations may further comprise determining that the core processing unit has a hardware resource configuration that meets or exceeds a combination of the first and second hardware resource requirements in response to the third plurality of hardware resource types including each of the hardware resource types in the first and second pluralities and, for each of the hardware resource types in either of the first and second pluralities, the number of units of the hardware resource type in the core processing unit is equal to or greater than the sum of the number of units of the hardware resource type required by the first inference workload instance and the number of units of the hardware resource type required by the second inference workload instance. While embodiments herein may be described in terms of a “first inference workload instance” using a “first inference model” and a “second inference workload instance” using a “second inference model”, it should be appreciated that the embodiments extend to third, fourth and any number of inference workload instances using third, fourth and any number of inference models. Accordingly, the terms “first” and “second” may be referring to any two inference workload instances using any two inference models.

In some embodiments, after identifying hardware resource requirements for running an inference workload instance that uses a particular inference model, any subsequent inference workload instances that use that inference model may be associated with the identified hardware resource requirements. This association an inference model and/or the inference workload instance that use the inference model with its hardware resource requirements may be referred to herein as “annotation.” For example, the association between an inference model with its resource requirements may be stored in inference model annotation records, such that inference workload instances that are submitted to the workload queue may be “annotated” or associated with the resource requirements. As previously described, the resource requirements of an inference model may be measured by running an inference workload instance that uses the inference model on a fully available core processing unit of a GPU and monitoring the types/amounts of hardware resources utilized. A software module that runs on the GPU where the inference workload instance is running to obtain the hardware resource utilization (requirements) data may be referred to as a tracer. If there are two inference workload instances on a single GPU, then two tracers may be used to monitor the types and amounts of resources used by each inference workload instance. In some options, the hardware resource requirements and corresponding inference workload annotation may be unique to each core processing unit hardware configuration. Accordingly, a given inference model may have multiple annotations for use in a system having multiple GPU specifications, where the annotation that is used will depend upon which of the GPUs has a core processing unit available. Annotation metrics (i.e., resource usage metric) may include a utilization amount for each of a plurality of resource types within the core processing unit. Non-limiting examples of resource types that may be present within a core processing unit include one or more levels of instruction cache, memory, warp scheduler, encode/decode engine, dispatch unit, register file, tensor core, load/store unit, selective forwarding unit, texture unit, various arithmetic logic units and more. The arithmetic logic units (ALUs) may include, without limitation, an FP32 unit (Single-Precision Floating-Point Unit), and an FP64 unit (Double-Precision Floating-Point Unit), and an INT32 unit (32-bit Signed Integer Unit). The amount of resource utilization for one or more of these resource types may, for example, be expressed in units of operations per second or percent utilization.

In some embodiments, the operations may further comprise measuring resource utilization of running a first representative inference workload instance that uses the first inference model on a representative core processing unit having the same hardware resource configuration as the core processing unit during a period that the representative core processing unit is not running any other inference workload instance, wherein the measured resource utilization of running the first representative inference workload instance on the representative core processing unit is used to identify the first hardware resource requirements; and measuring resource utilization of running a second representative inference workload instance that uses the second inference model on a representative core processing unit having the same hardware resource configuration as the core processing unit during a period that the representative core processing unit is not running any other inference workload instance, wherein the measured resource utilization of running the second representative inference workload instance on the representative core processing unit is used to identify the second hardware resource requirements. The operations may also comprise storing the measured resource utilization of running the first representative inference workload instance in association with identification of the first inference model and identification of the representative core processing unit; and storing the measured resource utilization of running the second representative inference workload instance in association with identification of the second inference model and identification of first representative core processing unit.

In some embodiment, the operations may further comprise causing a first tracer application instance to be performed on the representative core processing unit concurrent with the first representative inference workload instance, wherein the first tracer application measures the resource utilization of running the first representative inference workload instance on the representative core processing unit; and causing a second tracer application instance to be performed on the representative core processing unit concurrent with the second representative inference workload instance, wherein the second tracer application measures the resource utilization of running the second representative inference workload instance on the representative core processing unit. Although the tracers measure resource utilization on the core processing units within the inference computing resource pool, the resource utilization data may be reported to a workload affinity module or other software module for use in identifying whether to form one or more inference model affinity group.

In some embodiments, the operations may further comprise storing inference model affinity data that identifies, for each of a plurality of core processing unit configurations, a plurality of inference model affinity groups, wherein each inference model affinity group identifies two or more inference models having affinity to be run concurrently on a particular one of the core processing unit configurations, and wherein identifying whether the first and second inference models have affinity for being run concurrently on a particular hardware configuration of a core processing unit includes accessing the stored inference model affinity data.

Embodiments provide the technical benefit of improving the operation and functionality of a computer. Specifically, GPU compute resource utilizations and efficiencies, such as core processing unit utilizations, may be improved while also supporting the performance of high quality inference services that satisfy specific latency requirements and increase queries per second (QPS).

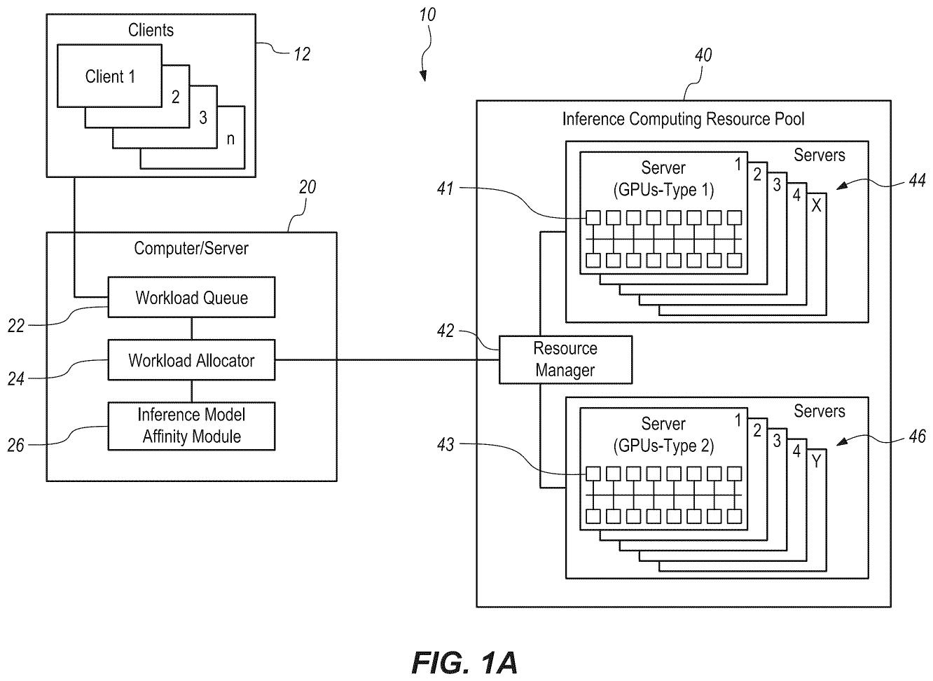

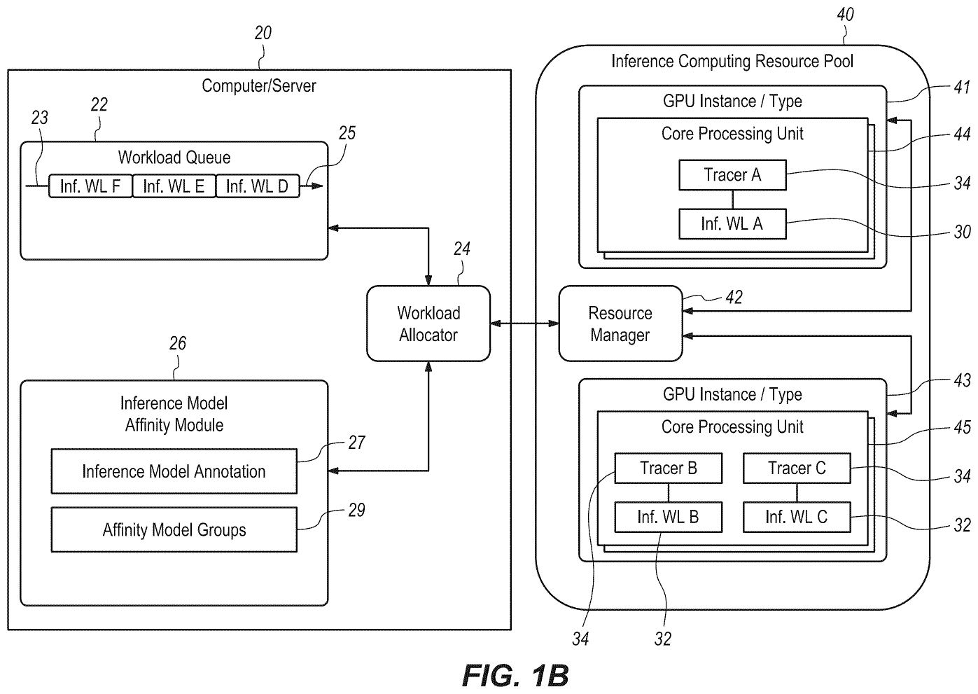

FIG. 1A is a diagram of a system 10 for improving the utilization of an inference computing resource pool 40 that uses affinity-aware concurrent launching of certain inference workloads. A computer or server 20 receives inference workload instances (not shown) from one or more clients 12 and places the inference workload instances in an inference workload queue 22. The computer 20 further includes a workload allocator 24 and an inference model affinity module 26. The workload allocator 24 communicates with the workload queue 22 to learn what inference workload instances are waiting to be run, communicates with a resource manager 42 of the inference computing resource pool 40 to learn what core processor units (not shown) within one of the GPUs 41 are available for receiving and running inference workload instances, and communicates with the inference model affinity module 26 to determine which of the inference workload instances within the workload queue 22 have affinity to be run concurrently on one of the available core processor units. Accordingly, the workload allocator 24 may launch a single inference workload instance to an available core processing unit and/or launch multiple inference workload instances to an available core processing unit according to one or more of the embodiments described herein.

The inference computing resource pool 40 is has servers 44, including server 1 through x that each have GPUs 41 (16 GPUs shown per server) of a first GPU type, model or version, as well as servers 46, including server 1 through y that each have GPUs 43 (16 GPUs shown per server) of a second GPU type, model or version. For the purpose of this illustration, GPUs 41 have core processing units (not shown) with a first hardware configuration and GPUs 43 have core processing units (not shown) with a second hardware configuration that is different than the first hardware configuration. The resource manager 42 monitors the servers 44, 46 and identifies core processing units that are available for running one or more inference workload instances. The resource manager 42 then shares the identification of the available core processing units with the workload allocator 24. When the workload allocator 24 launches one or more inference workload instance to be run by the available core processing unit, the workload allocator 24 passes an instruction and any supporting data and inference model information to the resource manager 42 for assignment and transfer to the available core processing unit. Output that is generated from the core processing unit running the inference workload instance(s) is returned to a client device 12 through the resource manager 42 and the computer 20.

FIG. 1B is a diagram of the system of FIG. 1A showing additional details. For example, the workload queue 22 illustrates a first-in, first-out queue including three inference workload instances that are waiting to be run. The workload queue 22 may have a tail end 23 and a head end 25, where newly submitted inference workload instances are added to the tail end 23 and work their way to the head end 25 where inference workload instances are given priority for launching to the inference computing resource pool 40. Each inference workload instance will include or identify an inference model and data that is to be processed by the inference model. Optionally, each inference workload instance may be associated with a priority level and a timestamp.

The inference model affinity module 26 includes a data structure storing inference model annotation data 27 that identifies the resource requirements of various inference models according to some embodiment. The inference model affinity module 26 also includes a data structure storing affinity model groups data 29 that identifies groups of two or more inference models that have affinity to be run concurrently on a core processing unit having a particular hardware configuration. Optionally, each affinity model group may be further associated with affinity resource metrics, such as a number of operations per second required of types of various arithmetic logic units (i.e., fp16/fp32/tf32 flops), memory reads/writes sizes, cache hits, etc.

The workload allocator 24 is a used for launching inference workload instances from the workload queue 22 to be performed by the inference computing resource pool 40. The workload allocator 24 may allocate or assign an individual inference workload instance or multiple inference workload instances as a workload group based on the resource availability information received from the resource manager 42 and affinity model groups data obtained from the workload affinity module 26. The resource manager 42 manages the current GPU resources, utilization, availability, etc.

In a further option, after an inference workload instance 30 or workload group 32 has been launched, a tracer 34 (for each workload) may be enabled and data may be collected by the tracer and reported to the affinity module 26 so that the affinity data (resource usage for each model, affinity pairings, etc.) can be update. For example, if one or both of the inference workload instances of the workload group (pair) 32 did not meet latency requirements, then the affinity module 26 may affinity model groups data 29 to negate or delete the affinity association between the two inference models as to the core processing units 45 of the GPU 43.

The workload allocator is initiated, then calls the resource manager to update the current GPU resource availability, which may include the availability of core processing units. The workload allocator may then initiate communication with the workload queue. The workload queue includes the inference workload instances (job requests), where each inference workload instance may be labeled with a priority and timestamp. Any given inference workload instance that is submitted to the workload queue at a different time may have a different priority. Accordingly, priority is specific to a particular inference workload instance rather than being associated with all inference workload instances of a particular inference model.

The workload allocator receives the current GPU resource availability from the resource manager and one or more inference workload instance from the workload queue, and checks with the workload affinity module for affinity data. Based on the (1) GPU resource availability, (2) the inference workload instances in the workload queue, and (3) the workload affinities, the workload allocator may then launch an inference workload instance from the workload queue to the inference computing resource pool either as a single workload or as a workload pair for performance by a core processing unit of a GPU.

The inference computing resource pool may enable a tracer for each new launched inference workload instance. For example, launching a single inference workload instance may be accompanied by launching a single tracer, whereas launching a workload pair (i.e., a workload group having a pair of inference workload instances) means launching two tracers to the same GPU where the two inference workload instances are to be run. The workload performance metrics (the GPU hardware resource status) obtained by the tracer during runtime are provided to the resource manager and shared with the computer 20, such as the inference model affinity module 29. The inference model affinity module may use the workload performance metrics to identify an affinity between two models (i.e., a model group pair) or update inference model annotation of resource requirements and/or the affinity groups data based upon the performance metrics generated by tracer programs and used to label/annotate the inference models and/or the affinity model groups. For each affinity model group, performance metrics are specific to both the identities of the inference models in the affinity model group and the GPU hardware resource (core processing unit) that was used to perform the affinity model group. When the performance of the inference workload instances has been completed, the tracers associated with the inference workloads may be disabled and the inference resources, such as the core processing units that were running those inference workload instances, may be returned (marked as available) to the inference resource pool.

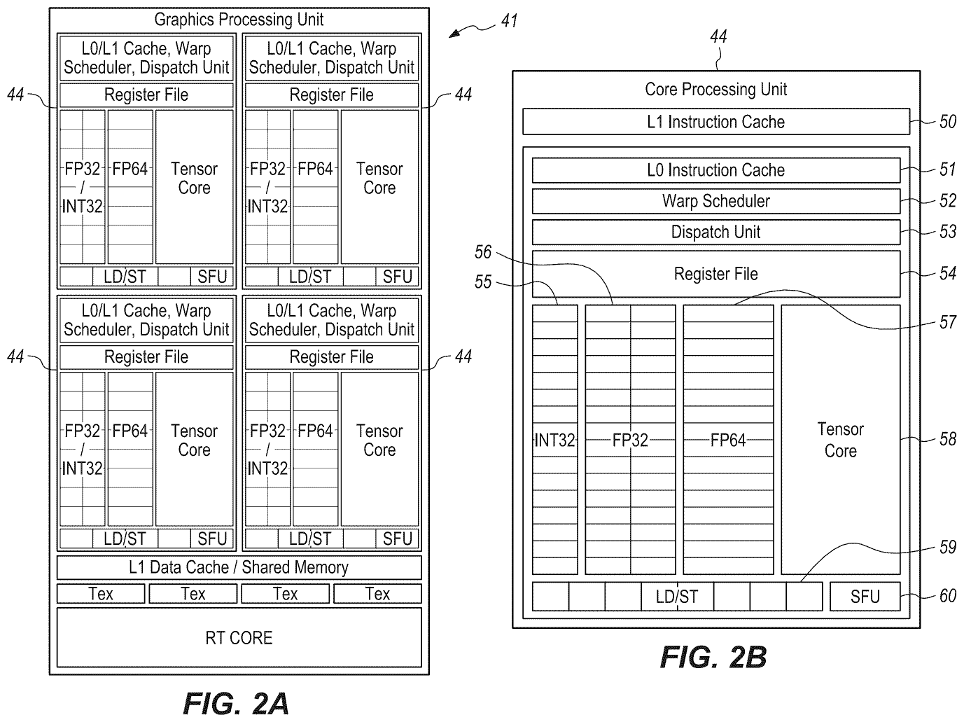

FIG. 2A is a diagram of a portion of a graphics processing unit 41 including four core processing units 44. Core processing units are the base organizing unit of the graphics processing unit (GPU) and each core processing unit, such as a streaming multiprocessor (SM), has a number of different compute engines, such as arithmetic logic units (ALUs), configured for work to be issued to them in parallel.

FIG. 2B is a diagram of a single core processing unit 44 that has the same or similar hardware resources as those in the GPU 41 of FIG. 2A but shown in greater detail. Specifically, the core processing unit 44 is shown having L1 instruction cache 50, L0 instruction cache 51, warp scheduler (32 thread/clk) 52, dispatch unit (32 thread/clk) 53, register file (16,384×32-bit) 54, 16 32-bit signed integer (INT32) units 55, 32 single-precision floating-point (FP32) units 56, 16 double-precision floating-point (FP64) units 57, tensor core 58, load/store (LD/ST) units 59, and selective forwarding unit (SFU) 60. Core processing units may have fewer or greater types and/or numbers of hardware resources than are shown in this example.

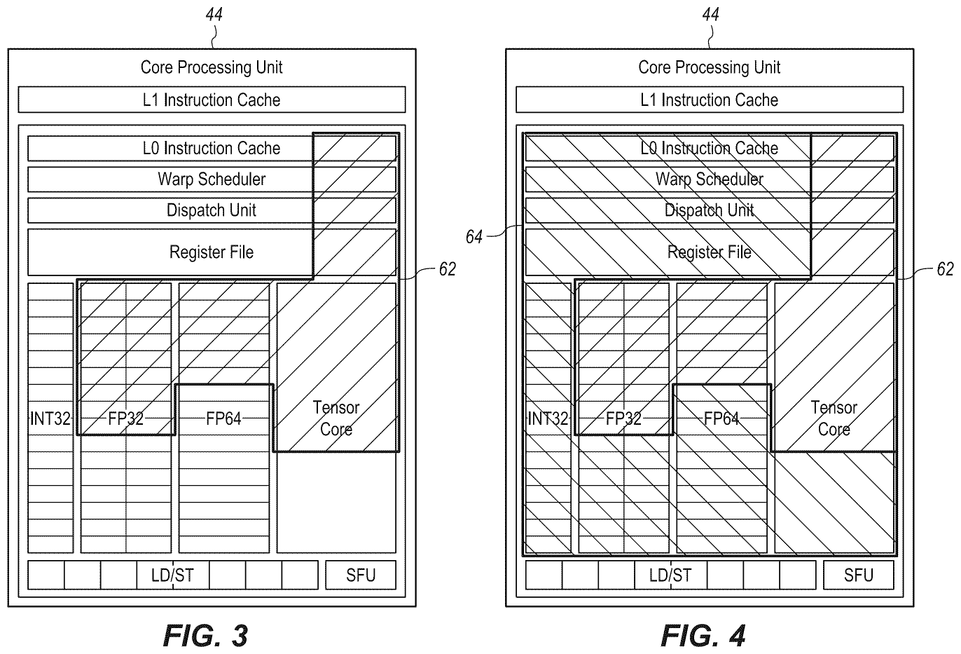

FIG. 3 is a diagram of the core processing unit 44 annotated to illustrate the hardware resources utilized by a first inference workload instance running alone on the core processing unit. Specifically, a shape 62 with a thick outline and cross-hatching (lower left to upper right) has been used to overlay the hardware resource requirements of the first inference workload instance to be run on this core processing unit. As previously described, these hardware resource requirements are a function of the inference model that is used by the first inference workload instance. Here, the hardware resource requirements or annotation for the first inference workload instance includes about 25% of the L0 instruction cache, about 25% of the warp scheduler, about 25% of the dispatch unit, about 25% of the register file, 18 of the single-precision floating-point (FP32) units, 6 of the double-precision floating-point (FP64) units, and about 60% of the tensor core. Accordingly, the core processing unit 44 clearly has sufficient hardware resources to support the operation of the first inference workload instance without any latency.

FIG. 4 is a diagram of the core processing unit 44 annotated to illustrate the hardware resources simultaneously utilized by a first inference workload instance (represented by shape 62) and a second inference workload instance (represented by shape 64). The affinity between these two illustrated inference workload instances 62, 64 is good (perhaps the best possible) for this particular core processing unit because there is no competition for the hardware resources (i.e., there is no overlap of the shapes 62, 64). “Affinity” means that the hardware resource requirements of two inference models allow the two inference models to run concurrently on the same core processing unit without leading to latency exceeding a latency limit or requirement, which can occur if there is any significant shortage of any individual resource type (INT32, FP 32, FP64, tensor core, register file, dispatch unit, warp scheduler, instruction cache, load/store, etc.).

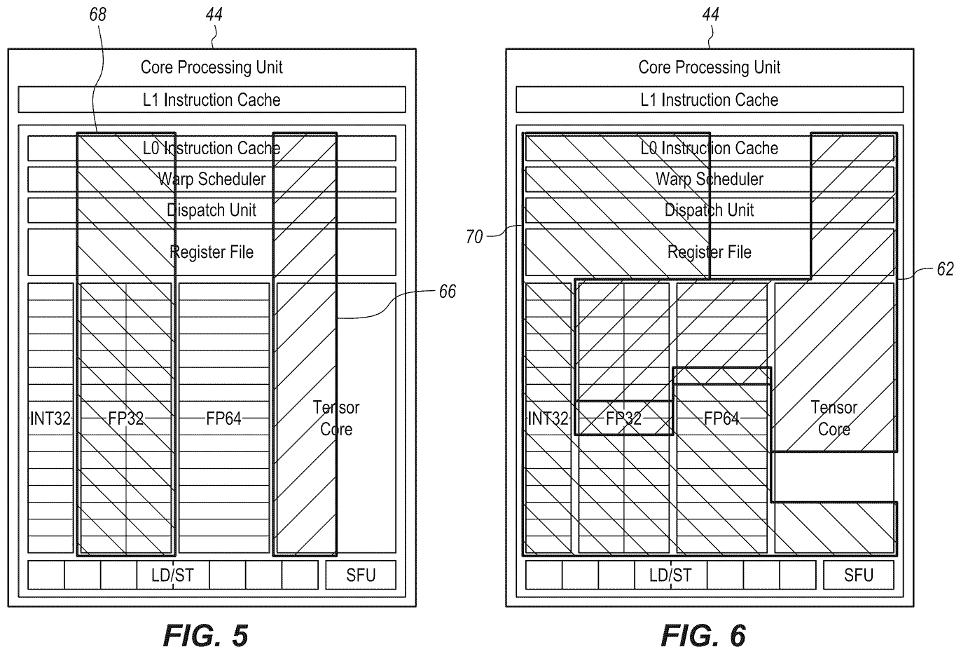

FIG. 5 is a diagram of the core processing unit 44 annotated to illustrate the hardware resources simultaneously utilized by a first inference workload instance (represented by shape 66) and a second inference workload instance (represented by shape 68) having good affinity (no competition for resources) for this particular core processing unit. With so many unused resources, an affinity model group might include both of these inference models as well as some additional inference models.

FIG. 6 is a diagram of the core processing unit 44 annotated to illustrate the hardware resources simultaneously utilized by a first inference workload instance (represented by shape 62) and a second inference workload instance (represented by shape 70) having good affinity (only minor competition for resources) for this particular core processing unit. This illustration emphasizes that a minor amount of competition between the inference workload instance for the hardware resources of the core processing unit does not alone negate affinity according to some embodiments, so long as the latency of concurrently running the inference workload instances on the same core processing unit does not exceed a predetermined latency limit. For example, the latency experienced by the first inference workload instance (represented by shape 62) when run concurrently with the second inference workload instance (represented by shape 70) may be determined by comparing the runtime of the first inference workload instance when run alone on the core processing unit (see FIG. 3) with the runtime of the first inference workload instance when run concurrently with the second inference workload instance (see FIG. 6).

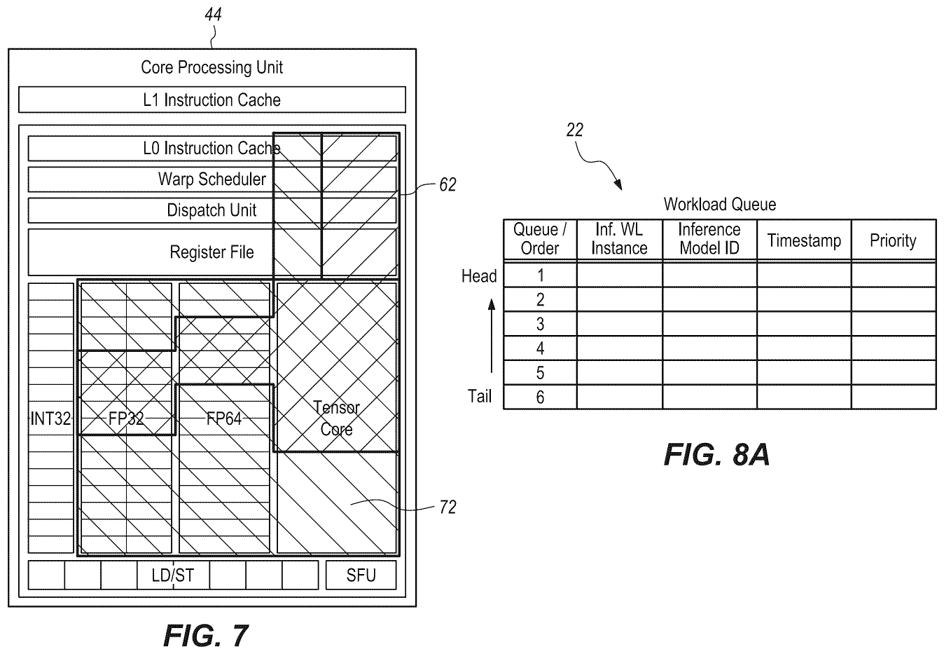

FIG. 7 is a diagram of the core processing unit 44 annotated to illustrate the hardware resources simultaneously utilized by a first inference workload instance (represented by shape 62) and a second inference workload (represented by shape 72) instance having bad affinity (major competition for resources) for this particular core processing unit 44. Concurrently running these two inference workload instances 62, 72 on the same core processing unit having the illustrated hardware configuration is highly likely to cause both inference workloads instances to experience latency exceeding a predetermined latency limit. In some embodiments, latency that does not exceed the predetermined latency limit may be the sole criteria for establishing affinity. In other embodiments, the lack of competition for the hardware resources of the core processing unit may be used as criteria for establishing affinity, perhaps subject to verification that the latency does not exceed the predetermined latency limit.

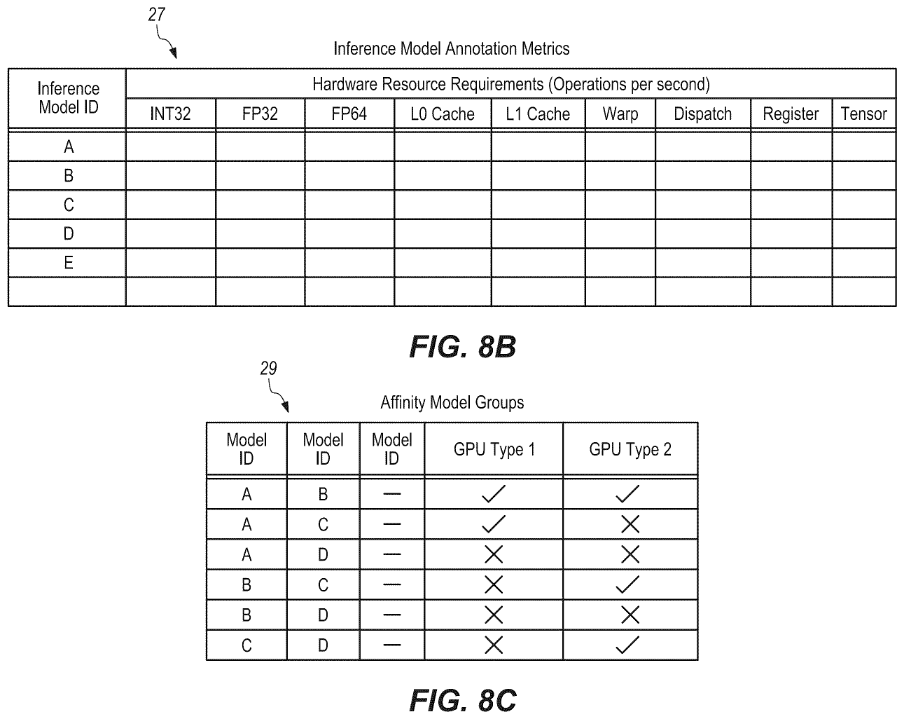

FIGS. 8A-C are illustrations of data structures that may be used to store a workload queue 22, inference model annotation metrics 27, and affinity model groups 29, respectively. The data structures are illustrated as tables, where each row represents a record, and each column represents a field of each record. However, other data structures, such as a comma delimited file.

In FIG. 8A, the workload queue 22 may store a plurality of records (rows) for each of a plurality of inference workload instances that have been submitted from clients to be run on the inference computing resource pool. Upon receipt, a new inference workload instance is entered into the tail of the workload queue and, in a first-in, first-out methodology, moves toward the head of the workload queue as other inference workload instances are launched to the inference computing resource pool. For each inference workload instance, the workload queue 22 may store the inference workload instance, inference model identifier, timestamp and priority.

In FIG. 8B, the inference model annotation metrics 27 include a record (row) for each inference model that may be run, or has to this point been run, on the inference computing resource pool. Each inference model record may include the hardware resource requirements of that particular inference model. For example, the hardware resource requirements may be measured and recorded in units of operations per second, such as floating point operations per second (FLOPS). In this example, the table includes columns (fields) for storing the number of resources required for each of a plurality of hardware resource types, such as INT32, FP32, FP64, L0 cache, L1 cache, warp, dispatch, register and tensor which have each been previously defined.

In FIG. 8C, the affinity model groups data 29 includes records identifying various combinations of inference models and whether or not that combination of inference models has affinity for being run concurrently on a core processing unit of the GPU Type 1 and/or GPU of Type 2. In this example, an indication of affinity may be a binary value indicating yes (“V”) or no (“X”). Other embodiments may include an affinity value, such as a value between 0 and 1, that indicates the strength or quality of the affinity as some inverse function of the latency. In this example, there are four inference models A, B, C and D forming six possible inference model pairs. Note that each affinity model group (row) could include a third inference model or even more than three inference models. Also note that some affinity model groups have affinity on both GPU Types whereas other affinity model groups no affinity on either GPU Type and yet other affinity model groups having affinity for one GPU type but not the other GPU type. In some options, only affinity model groups that have affinity for at least one GPU type will be included in the data structure.

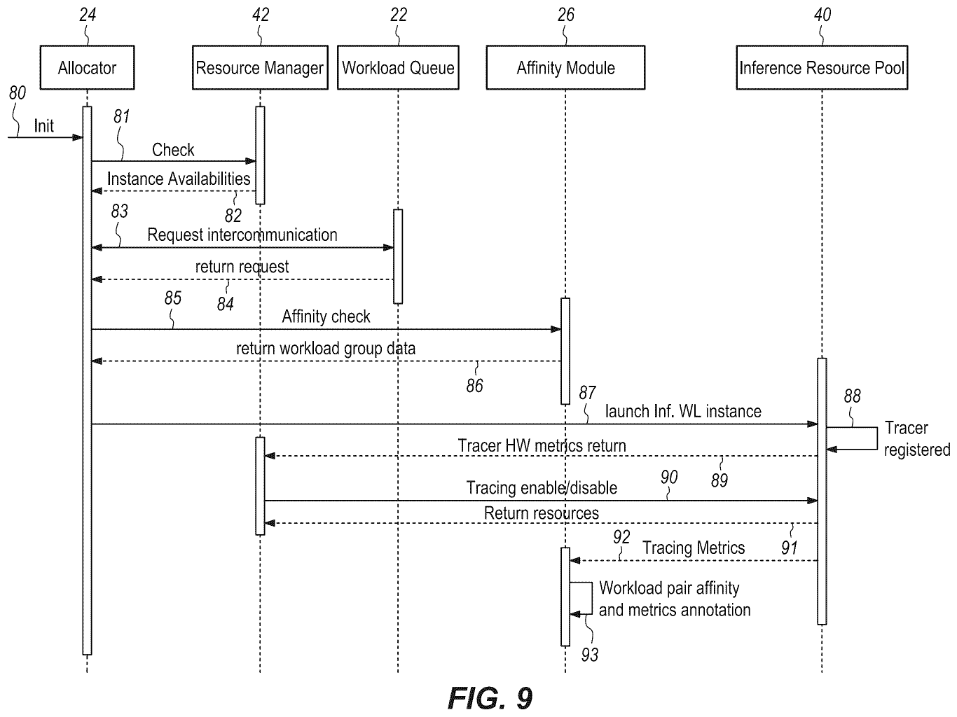

FIG. 9 is a flowchart (swim lane diagram) showing the interaction between entities of a system according to some embodiments. In operation 80, the workload allocator 24 is initiated, then calls the resource manager 42 to update the current GPU resource availability in operation 81. In operation 82, the resource manager 42 sends the GPU resource availability, such as the availability of a core processing unit and the type of core processing unit. In operation 83, the workload allocator 24 then initiates or requests communication with the workload queue 22. The workload queue 22 returns the request in operation 84 such that communication is established. The workload queue 22 may then provide the inference workload instances (job requests) to the workload allocator 24.

The workload allocator 24 then checks with the workload affinity module 26 in operation 85 and receives any relevant affinity data, such as an affinity model group including inference models that are used by inference workload instances present in the workload queue. Based on the (1) GPU resource availability (from operation 82), (2) the inference workload instances in the workload queue (from operation 84), and (3) the model affinity data (from operation 86), the workload allocator 24 may then, in operation 87, launch an inference workload instance from the workload queue 22 to the inference computing resource pool 40 either as a single workload or as a workload pair for performance by a core processing unit of a GPU.

The inference computing resource pool 40 may register and utilize a tracer for each newly launched inference workload instance in operation 88. For example, launching a single inference workload instance may be accompanied by launching a single tracer, whereas launching a workload pair (i.e., a workload group having a pair of inference workload instances) means launching two tracers to the same GPU where the two inference workload instances are to be run. The workload performance metrics (the GPU hardware resource status) obtained by the tracer during runtime are provided to the resource manager 42 in operation 89. When the performance of the inference workload instance(s) has been completed, the tracers associated with the inference workload(s) may be disabled in operation 90 and the inference resources, such as the core processing units that were running those inference workload instances, may be returned (marked as available) to the inference computing resource pool 40 in operation 91.

The tracing metrics obtained during the running of the inference workload instance(s) are shared with the computer 20, such as the inference model affinity module 26, in operation 92. Accordingly, in operation 93 the inference model affinity module 26 may use the workload performance metrics to identify an affinity between two models (i.e., a model group pair) or update inference model annotation of resource requirements and/or the affinity groups data based upon the performance metrics generated by tracer programs and used to label/annotate the inference models and/or the affinity model groups. For each affinity model group, performance metrics are specific to both the identities of the inference models in the affinity model group and the GPU hardware resource (core processing unit) that was used to perform the affinity model group.

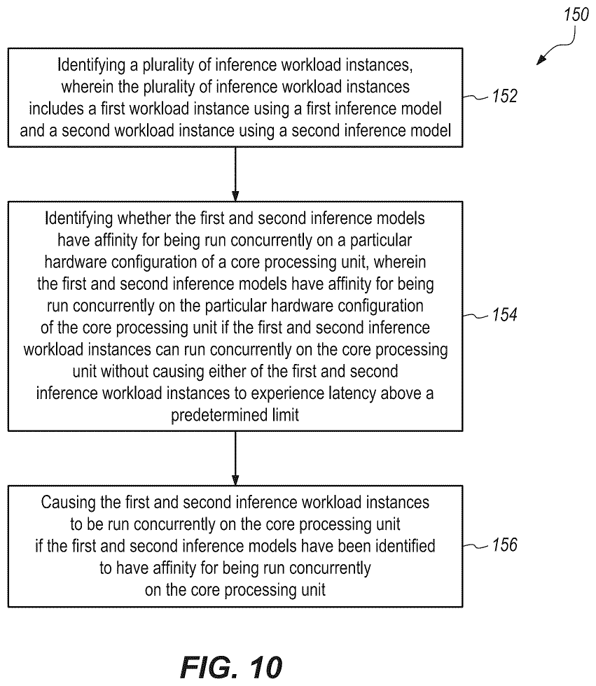

FIG. 10 is a flowchart of operations 150 according to some embodiments. Operation 152 include identifying a plurality of inference workload instances, wherein the plurality of inference workload instances includes a first inference workload instance using a first inference model and a second inference workload instance using a second inference model. Operation 154 include identifying whether the first and second inference models have affinity for being run concurrently on a particular hardware configuration of a core processing unit, wherein the first and second inference models have affinity for being run concurrently on the particular hardware configuration of the core processing unit if the first and second inference workload instances can run concurrently on the core processing unit without causing either of the first and second inference workload instances to experience latency above a predetermined limit. Operation 156 include causing the first and second inference workload instances to be run concurrently on the core processing unit if the first and second inference models have been identified to have affinity for being run concurrently on the core processing unit.

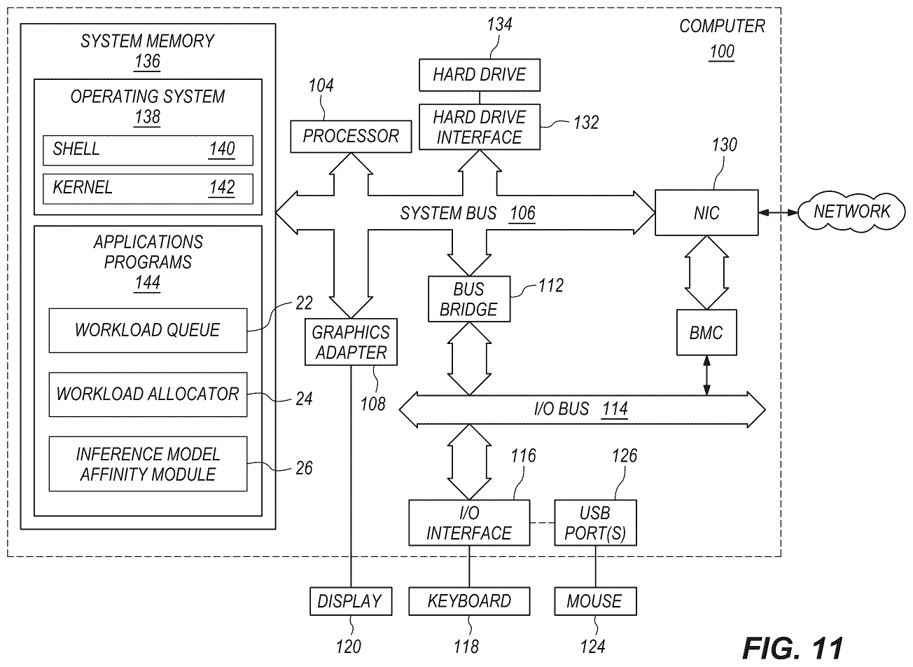

FIG. 11 is a block diagram of one embodiment of a computer 100 that may be representative, but not limiting, of the configuration of the computer 10 of FIG. 1A. The computer 100 includes a processor unit 104 that is coupled to a system bus 106. The processor unit 104 may utilize one or more processors, each of which has one or more processor cores. A graphics adapter 108, which drives/supports the display 120, is also coupled to system bus 106. The graphics adapter 108 may, for example, include a graphics processing unit (GPU). The system bus 106 is coupled via a bus bridge 112 to an input/output (I/O) bus 114. An I/O interface 116 is coupled to the I/O bus 114. The I/O interface 116 affords communication with various I/O devices, such as a keyboard 118 (perhaps as a touch screen virtual keyboard), and a USB mouse 124 via USB port(s) 126 (or other type of pointing device, such as a trackpad). As depicted, the computer 100 may communicate with other devices over a network using a network adapter or network interface controller (NIC) 130. The hardware elements depicted in the computer 100 are not intended to be exhaustive, but rather are representative. For instance, the computer 100 may include non-volatile memory and the like.

A hard drive interface 132 is also coupled to the system bus 106. The hard drive interface 132 interfaces with a hard drive 134. In a preferred embodiment, the hard drive 134 communicates with system memory 136, which is also coupled to the system bus 106. System memory is defined as the lowest level of volatile memory in the computer 100. This volatile memory may include additional higher levels of volatile memory (not shown), including, but not limited to, cache memory, registers and buffers. Data that populates the system memory 136 may include an operating system (OS) 138 and application programs 144. For example, the application programs 144 may include the workload queue 22, the workload allocator 24, and the inference model affinity module 26.

The operating system 138 includes a shell 140 for providing transparent user access to resources such as application programs 144. Generally, the shell 140 is a program that provides an interpreter and an interface between the user and the operating system. More specifically, the shell 140 executes commands that are entered into a command line user interface or from a file. Thus, the shell 140, also called a command processor, is generally the highest level of the operating system software hierarchy and serves as a command interpreter. The shell may provide a system prompt, interpret commands entered by keyboard, mouse, or other user input media, and send the interpreted command(s) to the appropriate lower levels of the operating system (e.g., a kernel 142) for processing. Note that while the shell 140 may be a text-based, line-oriented user interface, embodiments may support other user interface modes, such as graphical, voice, gestural, etc.

As depicted, the operating system 138 also includes the kernel 142, which may include lower levels of functionality for the operating system 138, including providing essential services required by other parts of the operating system 138 and application programs 144. Such essential services may include memory management, process and task management, disk management, and mouse and keyboard management. As shown, the computer 100 includes application programs 144 in the system memory of the computer 100.

The computer 100 further includes a management controller, illustrated here as a baseboard management controller (BMC). The BMC may be used to perform out-of-band processing and may monitor and manage various features of the hardware components of the computer via various sensors (not shown) and/or through the I/O bus 114. Furthermore, the BMC may run and/or be responsible for performing power management functions, such as providing over-current protection to multiple memory modules (see DDR5 DIMM 40 in FIGS. 1A-2B) that form the system memory 136.

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A computer program product comprising a non-volatile computer readable medium and non-transitory program instructions embodied therein, the program instructions being configured to be executable by a processor to cause the processor to perform operations comprising:
identifying a plurality of inference workload instances, wherein the plurality of inference workload instances includes a first inference workload instance using a first inference model and a second inference workload instance using a second inference model;
identifying whether the first and second inference models have affinity for being run concurrently on a particular hardware configuration of a core processing unit, wherein the first and second inference models have affinity for being run concurrently on the particular hardware configuration of the core processing unit if the first and second inference workload instances can run concurrently on the core processing unit without causing either of the first and second inference workload instances to experience latency above a predetermined limit; and
causing the first and second inference workload instances to be run concurrently on the core processing unit if the first and second inference models have been identified to have affinity for being run concurrently on the core processing unit.

2. The computer program product of claim 1, the operations further comprising:
preventing the first and second inference workload instances from being run concurrently on the core processing unit unless the first and second inference models have been identified to have affinity for being run concurrently on the core processing unit.

3. The computer program product of claim 1, wherein the first and second inference workloads are both identified in a workload queue, and wherein the first and second inference workloads are caused to run concurrently on the core processing unit by simultaneously launching the first and second inference workloads to be run on the core processing unit.

4. The computer program product of claim 1, wherein the first and second inference workload instances are caused to run concurrently on the core processing unit by launching the first inference workload instance from a workload queue to be run on the core processing unit and subsequently launching the second inference workload instance from the workload queue to be run on the core processing unit where the first inference workload instance is already running.

5. The computer program product of claim 1, the operations further comprising:
assigning inference workload instances within the workload queue to be run on the core processing unit on a first-in, first-out basis except that any identified inference workload instance within the workload queue may be selected to be run on the core processing unit out of order if the identified inference workload instance can be run concurrently with another inference workload instance that is being selected on the first-in, first out basis.

6. The computer program product of claim 1, wherein the core processing unit is one of multiple core processing units in a graphics processing unit.

7. The computer program product of claim 6, wherein the core processing unit is a streaming multiprocessor.

8. The computer program product of claim 1, the operations further comprising:
storing inference model affinity data that identifies a plurality of inference model affinity groups, wherein each inference model affinity group identifies two or more inference models having affinity to be run concurrently on the particular hardware configuration of the core processing unit.

9. The computer program product of claim 8, wherein identifying whether the first and second inference models have affinity for being run concurrently on a particular hardware configuration of a core processing unit includes accessing the stored inference model affinity data.

10. The computer program product of claim 8, wherein the plurality of inference model groups includes inference model pairs.

11. The computer program product of claim 8, wherein the plurality of inference model groups includes at least one inference model group where the two or more inference models include two or more instances of the same inference model.

12. The computer program product of claim 1, the operations further comprising:
storing inference model affinity data that identifies, for each of a plurality of core processing unit configurations, a plurality of inference model affinity groups, wherein each inference model affinity group identifies two or more inference models having affinity to be run concurrently on a particular one of the core processing unit configurations.

13. The computer program produce of claim 12, wherein the inference model affinity data includes at least one inference model affinity group that has affinity to be run concurrently on a first one of the core processing unit configurations and does not have affinity to be run concurrently on a second one of the core processing unit configurations.

14. The computer program product of claim 1, the operations further comprising:
verifying affinity between any two inference models by measuring an amount of latency experienced by either of the two workload instances using the two inference models that are being run concurrently on the core processing unit, wherein affinity between the first and second inference models for being run concurrently on a particular hardware configuration of a core processing unit is negated in response to the measured amount of latency experienced by either of the two workload instances exceeding a predetermined amount of latency relative to running the two workload instances on separate core processing units having the particular hardware configuration.

15. The computer program product of claim 14, wherein the predetermined amount of latency is defined by a service level agreement.

16. A computer program product comprising a non-volatile computer readable medium and non-transitory program instructions embodied therein, the program instructions being configured to be executable by a processor to cause the processor to perform operations comprising:
identifying a plurality of inference workload instances, wherein the plurality of inference workload instances includes a first inference workload instance using a first inference model and a second inference workload instance using a second inference model;
identifying whether the first and second inference models have affinity for being run concurrently on a particular hardware configuration of a core processing unit, wherein the first and second inference models have affinity for being run concurrently on the particular hardware configuration of the core processing unit if the core processing unit has a hardware resource configuration that meets or exceeds a combination of the hardware resource requirements of the first and second inference models; and
causing the first and second inference workload instances to be run concurrently on the core processing unit if the first and second inference models have been identified to have affinity for being run concurrently on the core processing unit.

17. The computer program product of claim 16, the operations further comprising:
identifying first hardware resource requirements for running an inference workload instance that uses the first inference model, wherein the first hardware resource requirements include a first plurality of hardware resource types and a number of units of each hardware resource type in the first plurality of hardware resource types;
identifying second hardware resource requirements for running an inference workload instance that uses the second inference model, wherein the second hardware resource requirements include a second plurality of hardware resource types and a number of units of each hardware resource type in the second plurality of hardware resource types;
identifying a hardware resource configuration of the core processing unit, wherein the hardware resource configuration includes a third plurality of hardware resource types and a number of units of each hardware resource type in the third plurality of hardware resource types; and
determining that the core processing unit has a hardware resource configuration that meets or exceeds a combination of the first and second hardware resource requirements in response to the third plurality of hardware resource types including each of the hardware resource types in the first and second pluralities and, for each of the hardware resource types in either of the first and second pluralities, the number of units of the hardware resource type in the core processing unit is equal to or greater than the sum of the number of units of the hardware resource type required by the first inference workload instance and the number of units of the hardware resource type required by the second inference workload instance.

18. The computer program product of claim 17, the operations further comprising:
measuring resource utilization of running a first representative inference workload instance that uses the first inference model on a representative core processing unit having the same hardware resource configuration as the core processing unit during a period that the representative core processing unit is not running any other inference workload instance, wherein the measured resource utilization of running the first representative inference workload instance on the representative core processing unit is used to identify the first hardware resource requirements;
measuring resource utilization of running a second representative inference workload instance that uses the second inference model on a representative core processing unit having the same hardware resource configuration as the core processing unit during a period that the representative core processing unit is not running any other inference workload instance, wherein the measured resource utilization of running the second representative inference workload instance on the representative core processing unit is used to identify the second hardware resource requirements;
storing the measured resource utilization of running the first representative inference workload instance in association with identification of the first inference model and identification of the representative core processing unit; and
storing the measured resource utilization of running the second representative inference workload instance in association with identification of the second inference model and identification of first representative core processing unit.

19. The computer program product of claim 18, the operations further comprising:
causing a first tracer application instance to be performed on the representative core processing unit concurrent with the first representative inference workload instance, wherein the first tracer application measures the resource utilization of running the first representative inference workload instance on the representative core processing unit; and
causing a second tracer application instance to be performed on the representative core processing unit concurrent with the second representative inference workload instance, wherein the second tracer application measures the resource utilization of running the second representative inference workload instance on the representative core processing unit.

20. The computer program product of claim 16, the operations further comprising:
storing inference model affinity data that identifies, for each of a plurality of core processing unit configurations, a plurality of inference model affinity groups, wherein each inference model affinity group identifies two or more inference models having affinity to be run concurrently on a particular one of the core processing unit configurations, and wherein identifying whether the first and second inference models have affinity for being run concurrently on a particular hardware configuration of a core processing unit includes accessing the stored inference model affinity data.
